(19) United States
(12) Patent Application Publication
(10) Pub. No.: US 2012/0230535 A1
(43) Pub. Date: Sep. 13, 2012

(54) ELECTRONIC DEVICE

(75) Inventor: Bill Yang, Taipei City (TW)

(73) Assignee: COTRON CORPORATION, Taipei City (TW)

(21) Appl. No.: 13/099,372

(22) Filed: May 3, 2011

(30) Foreign Application Priority Data
Mar. 8, 2011 (TW) 100107712

(51) Int. Cl. H04R 1/00

(52) U.S. Cl. 381/400; 381/396

(57) ABSTRACT

An electronic device includes a jack electrically connecting an outer speaker, a power controller, an audio generator electrically connecting the jack and the power controller, and an inner speaker. The inner speaker includes a housing, a magnet, a vibrating element, and a first electromagnetic inducting coil. The magnet and the vibrating element are configured in the housing. The vibrating element electrically connects the audio generator via the jack to be vibrated relatively to the magnet for sounding. The first electromagnetic inducting coil is configured on the vibrating element and electrically connected to the power controller to generate electricity induced by a magnetic field of the magnet. A power storage is charged by the electricity via the power controller. Through the jack and the power controller, the power storage is charged by electricity generated by a second electromagnetic inducting coil of the outer speaker.

### CROSS-REFERENCE TO RELATED APPLICATION

This application claims the priority benefit of Taiwan application serial no. 100107712, filed on Mar. 8, 2011. The entirety of the above-mentioned patent application is hereby incorporated by reference herein and made a part of this specification.

### BACKGROUND OF THE INVENTION

1. Field of the Invention

The invention relates to an electronic device. More particularly, the invention relates to an electronic device which can be charged by electricity generated by a speaker.

2. Description of Related Art

With the rapid progress in science and technology, all electronic products have been developed towards light, handy, and miniaturized designs. People may use miniaturized electronic products anytime and anyplace. Moreover, the personal digital products, such as common MP3 walkmans, tablet PCs, mobile phones, personal digital assistants (PDAs), or notebook computers, have increasingly become popular, and thus these products are indispensable in the daily life.

These electronic devices are often portable, and thus functions including playing music, voice communication, and internet access are performed with restricted electricity. Accordingly, how to improve the electrical capacity of the electronic device in order to prolong the use of the electronic device becomes an essential topic.

### SUMMARY OF THE INVENTION

The invention is directed to an electronic device of which electrical capacity can be increased, such that the use time of the electronic device can be extended.

In an embodiment of the invention, an electronic device includes a jack, a power controller, an audio generator, and an inner speaker. The jack electrically connects an outer speaker. The power controller is suitable for electrically connecting a power storage. The audio generator electrically connects the jack and the power controller. The inner speaker includes a housing, a magnet, a first vibrating element, and a first electromagnetic inducting coil. The magnet is configured in the housing. The first vibrating element is configured in the housing and electrically connected to the audio generator via the jack to be vibrated relatively to the magnet for sounding. The first electromagnetic inducting coil is configured on the first vibrating element and electrically connected to the power controller to generate electricity induced by a magnetic field of the magnet. A power storage is charged by the electricity generated by the first electromagnetic inducting coil. Here, the power storage is charged via the power controller. The outer speaker has a second electromagnetic inducting coil. The power storage is charged by electricity generated by the second electromagnetic inducting coil. Here, the power storage is charged via the jack and the power controller. The power controller is electrically connected to the first electromagnetic inducting coil or the jack selectively.

According to an embodiment of the invention, the first vibrating element includes a diaphragm and a sounding coil configured on the diaphragm. The first electromagnetic inducting coil is configured on the diaphragm. In addition, the sounding coil is electrically connected to the audio generator via the jack, for instance.

According to an embodiment of the invention, the power controller includes a rectifier and a power management chip. The first electromagnetic inducting coil and the second electromagnetic inducting coil are electrically connected to the rectifier. The rectifier is electrically connected to the power management chip. The power management chip is adapted for electrically connecting the power storage. Besides, the power management chip is electrically connected to the audio generator, for instance.

According to an embodiment of the invention, the jack includes eleven terminals. A first terminal is adapted for electrically connecting a second vibrating element of a first speaker of the outer speaker via a first audio terminal of a plug of the outer speaker. A second terminal is electrically connected to a first audio output port of the audio generator. A third terminal is electrically connected to the first vibrating element. The second terminal is electrically connected to the first terminal or the third terminal selectively. A fourth terminal is electrically connected to the first electromagnetic inducting coil and a fourth power input port of the power controller. Here, the fourth terminal is adapted for electrically connecting the second electromagnetic inducting coil of the first speaker via a fourth power terminal of the plug. A fifth terminal is electrically connected to the first electromagnetic inducting coil. A sixth terminal is electrically connected to a third power input port of the power controller. A seventh terminal is adapted for electrically connecting the second electromagnetic inducting coil via a third power terminal of the plug. The sixth terminal is electrically connected to the fifth terminal or the seventh terminal selectively. An eighth terminal is electrically connected to a second power input port of the power controller. Here, the eighth terminal is adapted for electrically connecting a third electromagnetic inducting coil of a second speaker of the outer speaker via a second power terminal of the plug. A ninth terminal is electrically connected to a first power input port of the power controller. Here, the ninth terminal is adapted for electrically connecting the third electromagnetic inducting coil via a first power terminal of the plug. The power storage is charged by electricity generated by the third electromagnetic inducting coil. Here, the power storage is charged via the jack and the power controller. A tenth terminal is electrically connected to a second audio output port of the audio generator. Here, the tenth terminal is adapted for electrically connecting a third vibrating element of the second speaker via a second audio terminal of the plug. An eleventh terminal is electrically connected to the first vibrating element and a ground port of the audio generator. Here, the eleventh terminal is adapted for electrically connecting the second vibrating element and the third vibrating element via a ground terminal of the plug.

According to an embodiment of the invention, the electronic device further includes an electronic switch electrically connected to the power controller. The electronic switch is electrically connected to the first electromagnetic inducting coil or the jack selectively.

According to an embodiment of the invention, the electronic device further includes a protection circuit electrically connected to the power controller and the jack for cutting off the electrical connection between the power controller and the jack before the power controller is overloaded or for restricting an amount of the electricity output to the power controller from the second electromagnetic inducting coil before the power controller is overloaded.

Based on the above-mentioned electronic device as described in the embodiments of the invention, the power storage can be charged by the electricity generated by the electromagnetic inducting coils of the inner speaker and the outer speaker. Here, the power storage is charged via the power controller. Accordingly, the amount of electricity stored in the power storage can be increased, and the use time of the electronic device can be extended.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an electronic device connected to an outer speaker according to an embodiment of the invention.

FIG. 2 is a cross-sectional view illustrating an inner speaker of the electronic device depicted in FIG. 1.

FIG. 3 is a schematic view illustrating an electronic device connected to an outer speaker according to another embodiment of the invention.

FIG. 4 is a schematic view illustrating an electronic device connected to an outer speaker according to still another embodiment of the invention.

### DESCRIPTION OF EMBODIMENTS

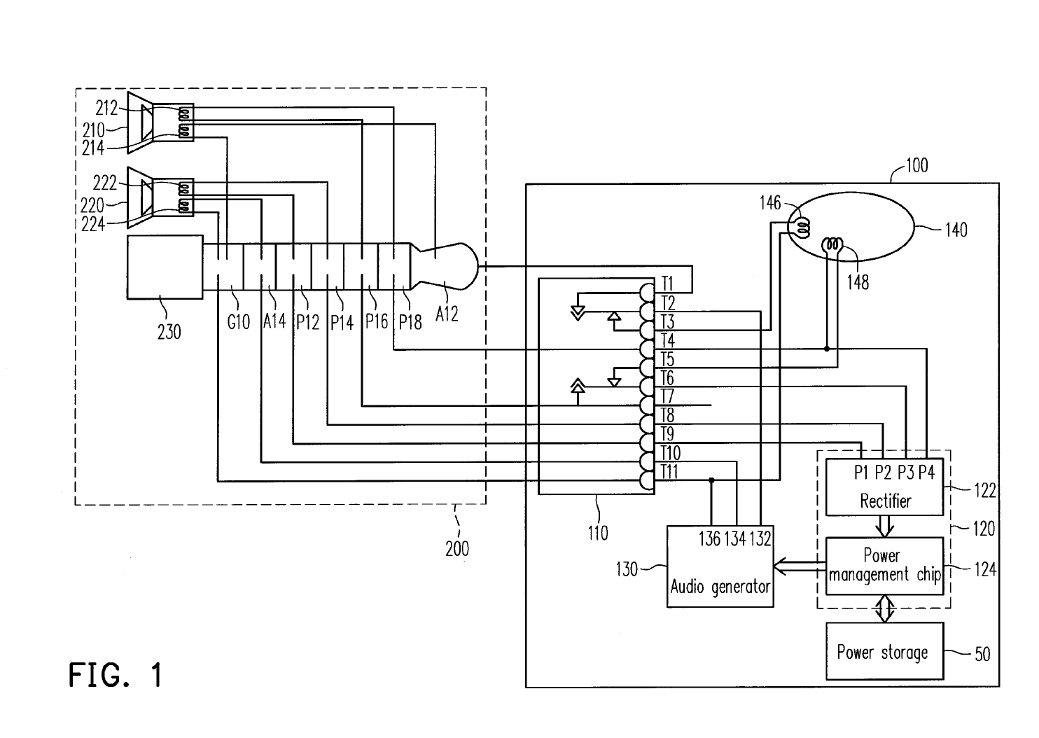

FIG. 1 is a schematic view illustrating an electronic device connected to an outer speaker according to an embodiment of the invention. With reference to FIG. 1, the electronic device 100 of this embodiment includes a jack 110, a power controller 120, an audio generator 130, and an inner speaker 140. According to this embodiment, the electronic device 100 is a mobile phone, for instance, while the electronic device in other embodiments of the invention can also be a tablet PC, an MP3 walkman, or any other electronic device. The jack 110 is adapted for electrically connecting an outer speaker 200. Namely, the outer speaker 200 is an external accessory to the electronic device 100. Note that the electronic device 100 can still be used even though the electronic device 100 is not connected to the outer speaker 200. In this embodiment, the outer speaker 200 is an earphone, for instance, while the outer speaker 200 can also be a speaker that can directly sound for people to hear. The power controller 120 is adapted for electrically connecting a power storage 50. From the power storage 50, the power controller 120 can obtain electricity required for operating the electronic device 100 and distribute the electricity to each element in the electronic device 100. The audio generator 130 electrically connects the jack 110 and the power controller 120.

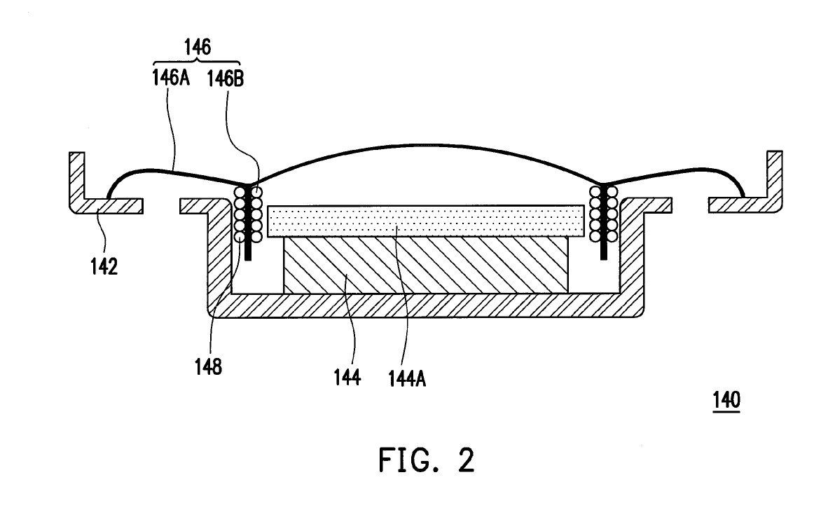

FIG. 2 is a cross-sectional view illustrating an inner speaker of the electronic device depicted in FIG. 1. With reference to FIG. 1 and FIG. 2, the inner speaker 140 of this embodiment includes a housing 142, a magnet 144, a first vibrating element 146, and a first electromagnetic inducting coil 148. The magnet 144 is configured in the housing 142. The first vibrating element 146 is configured in the housing 142 to be vibrated relatively to the magnet 144 for sounding. Besides, the first vibrating element 146 is electrically connected to the audio generator 130 via the jack 110. The first electromagnetic inducting coil 148 is configured on the first vibrating element 146 and electrically connected to the power controller 120 to generate electricity induced by a magnetic field of the magnet 144. The inner speaker 140 of this embodiment can further include a pole piece 144A configured on the magnet 144.

When the inner speaker 140 sounds, the first vibrating element 146 vibrates relatively to the magnet 144 and drives the first electromagnetic inducting coil 148 on the first vibrating element 146 to vibrate relatively to the magnet 144. The magnetic field of the magnet 144 induced by the first electromagnetic inducting coil 148 varies in terms of intensity and direction, and thereby electricity can be generated. The power storage 50 is charged by the electricity generated by the first electromagnetic inducting coil 148. Here, the power storage 50 is charged via the power controller 120. Accordingly, even though the inner speaker 140 of this embodiment consumes electricity in order to sound, the first electromagnetic inducting coil 148 of the inner speaker 140 can generate electricity. The power storage 50 can be charged by the electricity generated by the first electromagnetic inducting coil 148 to operate the electronic device 100, which complies with the current trend of reducing energy consumption and carbon emissions. Similar to the inner speaker 140, the outer speaker 200 that can be connected to the electronic device 100 also has a second electromagnetic inducting coil 212. The power storage 50 can be charged by electricity generated by the second electromagnetic inducting coil 212. Here, the power storage 50 is charged via the jack 110 and the power controller 120. In other words, the first electromagnetic inducting coil 148 of the inner speaker 140 and the second electromagnetic inducting coil 212 of the outer speaker 200 can share the power controller 120, and the power controller 120 can process the electricity generated by the first electromagnetic inducting coil 148 and the second electromagnetic inducting coil 212.

The power controller 120 is electrically connected to the jack 110 or the first electromagnetic inducting coil 148 selectively. That is to say, when the power controller 120 processes the electricity generated by the first electromagnetic inducting coil 148, the power controller 120 does not process the electricity output by the second electromagnetic inducting coil 212 from the jack 110. Alternatively, the jack 110 is not connected to the outer speaker 200 when the power controller 120 processes the electricity generated by the first electromagnetic inducting coil 148. By contrast, when the power controller 120 processes the electricity output by the second electromagnetic inducting coil 212 from the jack 110, the power controller 120 does not process the electricity generated by the first electromagnetic inducting coil 148. Alternatively, the first electromagnetic inducting coil 148 does not generate the electricity when the power controller 120 processes the electricity output by the second electromagnetic inducting coil 212 from the jack 110. Whether the power controller 120 is electrically connected to the first electromagnetic inducting coil 148 or the jack 110 can be determined by a mechanical switch or an electronic switch.

As shown in FIG. 2, the first vibrating element 146 of this embodiment includes a diaphragm 146A and a sounding coil 146B configured on the diaphragm 146A. The first electromagnetic inducting coil 148 is configured on the diaphragm 146A. When the magnetic field of the sounding coil 146B varies together with variations in electrical signals input to the sounding coil 146B, the magnetic field of the sounding coil 146B interacts with the magnetic field of the magnet 144 to move the sounding coil 146B, and thereby the diaphragm 146A is driven to vibrate and sound. However, in other embodiments of the invention, the first vibrating element 146 can be any other type of vibrating element. As long as the first electromagnetic inducting coil 148 on the first vibrating element 146 can be driven to vibrate relatively to the magnet 144, the first electromagnetic inducting coil 148 can generate electricity induced by the magnetic field of the magnet 144.

With reference to FIG. 1, the sounding coil 146 of this embodiment is electrically connected to the audio generator 130 via the jack 110, for instance, so as to receive audio signals from the audio generator 130. In this embodiment, the power controller 120 includes a rectifier 122 and a power management chip 124. The first electromagnetic inducting coil 148 is electrically connected to the rectifier 122 via the jack 110. When a plug 230 of the outer speaker 200 is inserted into the jack 110, the switching function is performed by mechanisms of the jack 110. Namely, the electrical connection between the first electromagnetic inducting coil 148 and the rectifier 122 is cut off; meanwhile, the second electromagnetic inducting coil 212 is electrically connected to the rectifier 122 via the jack 110. Namely, whether the power controller 120 is electrically connected to the first electromagnetic inducting coil 148 or the jack 110 can be determined by a mechanical switch. The rectifier 122 is electrically connected to the power management chip 124. The electricity generated by the first electromagnetic inducting coil 148 and the electricity generated by the second electromagnetic inducting coil 212 are often alternating currents, and the amount of the electricity is inconstant. Accordingly, the rectifier 122 is required for voltage boost and current stabilization. After that, the electricity is supplied to the power management chip 124. The power management chip 124 is adapted for electrically connecting the power storage 50, and the power management chip 124 can also be electrically connected to the audio generator 130. Note that the power storage 50 is an accessory to the electronic device 100, and the electronic device 100 which is not equipped with the power storage 50 does not go beyond the scope of the invention. At present, the charging procedures of the power storage 50 in the market are rather complicated. Therefore, by means of the power management chip 124 that can control and monitor the charging procedures, the power storage 50 can be ideally charged. For instance, the power management chip 124 manipulates the power charge of the power storage 50 through a constant current approach in the primary stage of power charge. After an output voltage of the power storage 50 stably reaches a predetermined value, the power management chip 124 manages to continually charge the power storage 50 through the constant voltage approach.

The jack 110 of this embodiment includes eleven terminals. A first terminal T1 is adapted for electrically connecting a second vibrating element 214 of a first speaker 210 of the outer speaker 200 via a first audio terminal A12 of a plug 230 of the outer speaker 200. A second terminal T2 is electrically connected to a first audio output port 132 of the audio generator 130. A third terminal T3 is electrically connected to the first vibrating element 146. The second terminal T2 can be electrically connected to the first terminal T1 or the third terminal T3 selectively. Namely, the audio signals output from the first audio output port 132 of the audio generator 130 can be transmitted to the first speaker 210 from the first terminal T1 or transmitted to the inner speaker 140 from the third terminal T3. In most cases, when the plug 230 of the outer speaker 200 is not connected to the jack 110, the second terminal T2 is electrically connected to the third terminal T3. When the plug 230 of the outer speaker 200 is connected to the jack 110, the second terminal T2 is automatically switched to be electrically connected to the first terminal T1. Certainly, the second terminal T2 can be electrically connected to the first and third terminals T1 and T3 simultaneously.

A fourth terminal T4 is electrically connected to the first electromagnetic inducting coil 148 and a fourth power input port P4 of the power controller 120. Here, the fourth terminal T4 is adapted for electrically connecting the second electromagnetic inducting coil 212 of the first speaker 210 via a fourth power terminal P18 of the plug 230. A fifth terminal T5 is electrically connected to the first electromagnetic inducting coil 148. A sixth terminal T6 is electrically connected to a third power input port P3 of the power controller 120. A seventh terminal T7 is adapted for electrically connecting the second electromagnetic inducting coil 212 via a third power terminal P16 of the plug 230. The sixth terminal T6 can be electrically connected to the fifth terminal T5 or the seventh terminal T7 selectively. When the plug 230 of the outer speaker 200 is not connected to the jack 110, the sixth terminal T6 is electrically connected to the fifth terminal T5, such that the electricity generated by the first electromagnetic inducting coil 148 can be transmitted to the power controller 120. By contrast, when the plug 230 of the outer speaker 200 is connected to the jack 110, the sixth terminal T6 is automatically switched to be electrically connected to the seventh terminal T7, such that the electricity generated by the second electromagnetic inducting coil 212 can be transmitted to the power controller 120. Certainly, the sixth terminal T6 can be electrically connected to the fifth and seventh terminals T5 and T7 simultaneously.

An eighth terminal T8 is electrically connected to a second power input port P2 of the power controller 120. Here, the eighth terminal T8 is adapted for electrically connecting a third electromagnetic inducting coil 222 of a second speaker 220 of the outer speaker 200 via a second power terminal P14 of the plug 230. A ninth terminal T9 is electrically connected to a first power input port P1 of the power controller 120. Here, the ninth terminal T9 is adapted for electrically connecting the third electromagnetic inducting coil 222 via a first power terminal P12 of the plug 230. The power storage 50 can be charged by electricity generated by the third electromagnetic inducting coil 222. Here, the power storage 50 is charged via the jack 110 and the power controller 120. A tenth terminal T10 is electrically connected to a second audio output port 134 of the audio generator 130. Here, the tenth terminal T10 is adapted for electrically connecting a third vibrating element 224 of the second speaker 220 via a second audio terminal A14 of the plug 230. An eleventh terminal T11 is electrically connected to the first vibrating element 146 and a ground port 136 of the audio generator 130. Here, the eleventh terminal T11 is adapted for electrically connecting the second vibrating element 214 and the third vibrating element 224 via a ground terminal G10 of the plug 230. What is described above refers to one way to carry out the invention according to an embodiment of the invention, which should not be construed as a limitation to the invention.

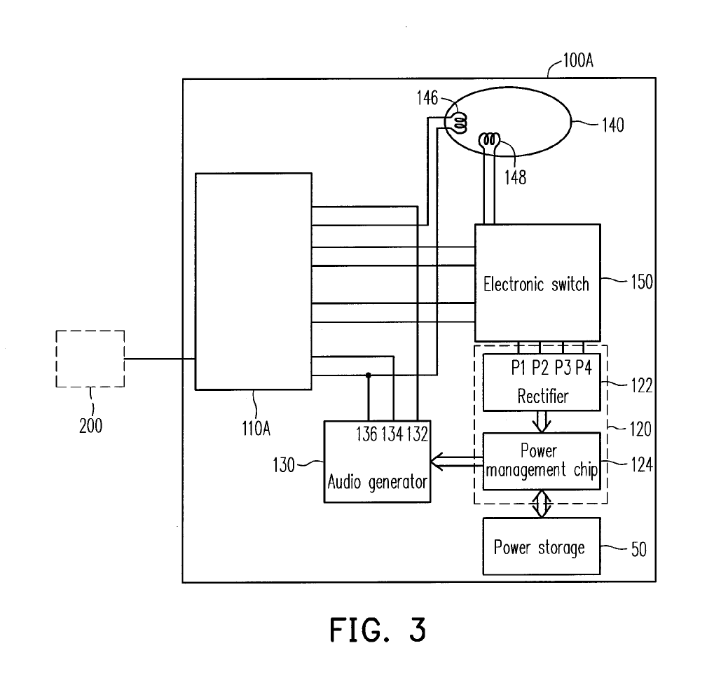

FIG. 3 is a schematic view illustrating an electronic device connected to an outer speaker according to another embodiment of the invention. With reference to FIG. 3, the electronic device 100A of this embodiment is similar to the electronic device 100 depicted in FIG. 1, while the difference therebetween lies in that the electronic device 100A of this embodiment further includes an electronic switch 150 electrically connected to the power controller 120, the first electromagnetic inducting coil 148, and the jack 110A. That is to say, the electronic switch 150 of this embodiment replaces the mechanical switch of the jack 110 depicted in FIG. 1. Whether the power controller 120 is electrically connected to the first electromagnetic inducting coil 148 or the jack 110A can be determined by the electronic switch 150.

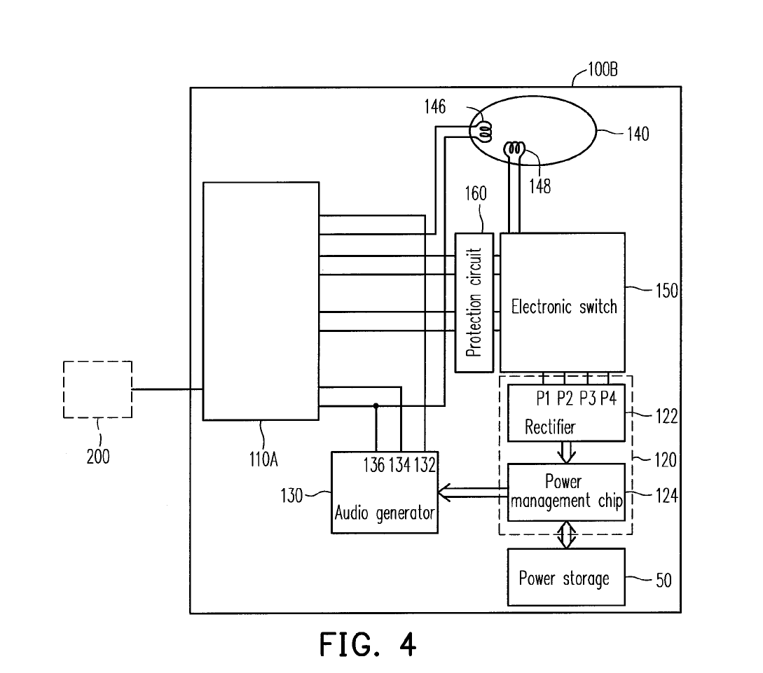

FIG. 4 is a schematic view illustrating an electronic device connected to an outer speaker according to still another embodiment of the invention. With reference to FIG. 4, the electronic device 100B of this embodiment is similar to the electronic device 100A depicted in FIG. 3, while the difference therebetween lies in that the electronic device 100B of this embodiment further includes a protection circuit 160 electrically connected to the power controller 120 and the electronic switch 150. The protection circuit 160 serves to cut off the electrical connection between the power controller 120 and the jack 110A before the power controller 120 is overloaded. Alternatively, the protection circuit 160 can restrict the amount of the electricity output to the power controller 120 from the second electromagnetic inducting coil 212 before the power controller 120 is overloaded. For instance, the protection circuit 160 can assure the voltage value or the current value of the electricity output from the second electromagnetic inducting coil 212 to the power controller 120 to be equal to or below a threshold value. Whether the electricity output from the outer speaker connected to the plug 110A is excessive or not is unpredictable. Since the protection circuit 160 can protect the power controller 120 which is rather expensive and is likely to affect operation of other components in the electronic device 100B, the power controller 120 can be protected from being overloaded and burned out by applying the protection circuit 160. Undoubtedly, the protection circuit 160 can also be applied to the electronic device 100 depicted in FIG. 1, e.g., installed between the power controller 120 and the jack 110. Similarly, the protection circuit 160 can cut off the electrical connection between the power controller 120 and the jack 110 before the power controller 120 is overloaded.

In light of the foregoing, the inner speaker of the electronic device described in the embodiments of the invention has the electromagnetic inducting coil that can generate electricity induced by the magnetic field of the magnet. Besides, the electronic device described in the embodiments of the invention is adapted for connecting the outer speaker having the electromagnetic inducting coil that can generate electricity induced by the magnetic field of the magnet. Meanwhile, as described in the embodiments of the invention, the power storage can be charged by the electricity generated by the electromagnetic inducting coils of the inner speaker and the outer speaker. Here, the power storage is charged via the power controller. Thereby, the electricity stored in the power storage can be increased, and the use time of the electronic device can be extended. Namely, the environmental concern of reducing energy consumption and carbon emissions is taken into account. The design of recycling the electricity to extend the use time of the electronic device, as described in the embodiments of the invention, may be of great help to a user of the electronic device at the crucial moment.

Although the invention has been described with reference to the above embodiments, it will be apparent to one of the ordinary skill in the art that modifications to the described embodiments may be made without departing from the spirit of the invention. Accordingly, the scope of the invention will be defined by the attached claims rather than by the above detailed descriptions.

What is claimed is:

1. An electronic device comprising:
a jack for electrically connecting an outer speaker;
a power controller for electrically connecting a power storage;
an audio generator electrically connected to the jack and the power controller; and
an inner speaker comprising:
a housing;
a magnet configured in the housing;
a first vibrating element configured in the housing and electrically connected to the audio generator via the jack, the first vibrating element being vibrated relatively to the magnet for sounding; and
a first electromagnetic inducting coil configured on the first vibrating element and electrically connected to the power controller to generate electricity induced by a magnetic field of the magnet, through the power controller, the power storage being charged by the electricity generated by the first electromagnetic inducting coil, the outer speaker having a second electromagnetic inducting coil, through the jack and the power controller, the power storage being charged by electricity generated by the second electromagnetic inducting coil, the power controller being electrically connected to the first electromagnetic inducting coil or the jack selectively.

2. The electronic device as claimed in claim 1, wherein the first vibrating element comprises a diaphragm and a sounding coil configured on the diaphragm, and the first electromagnetic inducting coil is configured on the diaphragm.

3. The electronic device as claimed in claim 2, wherein the sounding coil is electrically connected to the audio generator via the jack.

4. The electronic device as claimed in claim 1, wherein the power controller comprises a rectifier and a power management chip, the first electromagnetic inducting coil and the second electromagnetic inducting coil are electrically connected to the rectifier, the rectifier is electrically connected to the power management chip, and the power management chip is for being electrically connected to the power storage.

5. The electronic device as claimed in claim 4, wherein the power management chip is electrically connected to the audio generator.

6. The electronic device as claimed in claim 1, wherein the jack comprises:
a first terminal for electrically connecting a second vibrating element of a first speaker of the outer speaker via a first audio terminal of a plug of the outer speaker;
a second terminal electrically connected to a first audio output port of the audio generator;
a third terminal electrically connected to the first vibrating element, the second terminal being electrically connected to the first terminal or the third terminal selectively;
a fourth terminal for electrically connecting the second electromagnetic inducting coil of the first speaker via a fourth power terminal of the plug, the fourth terminal being electrically connected to the first electromagnetic inducting coil and a fourth power input port of the power controller;
a fifth terminal electrically connected to the first electromagnetic inducting coil;
a sixth terminal electrically connected to a third power input port of the power controller;
a seventh terminal for electrically connecting the second electromagnetic inducting coil via a third power terminal of the plug, the sixth terminal being electrically connected to the fifth terminal or the seventh terminal selectively;
an eighth terminal for electrically connecting a third electromagnetic inducting coil of a second speaker of the outer speaker via a second power terminal of the plug, the eighth terminal being electrically connected to a second power input port of the power controller;
a ninth terminal for electrically connecting the third electromagnetic inducting coil via a first power terminal of the plug, the ninth terminal being electrically connected to a first power input port of the power controller, through the jack and the power controller, the power storage being charged by electricity generated by the third electromagnetic inducting coil;
a tenth terminal for electrically connecting a third vibrating element of the second speaker via a second audio terminal of the plug, the tenth terminal being electrically connected to a second audio output port of the audio generator; and
an eleventh terminal for electrically connecting the second vibrating element and the third vibrating element via a ground terminal of the plug, the eleventh terminal being electrically connected to the first vibrating element and a ground port of the audio generator.

7. The electronic device as claimed in claim 1, further comprising an electronic switch electrically connected to the power controller, the electronic switch being electrically connected to the first electromagnetic inducting coil or the jack selectively.

8. The electronic device as claimed in claim 1, further comprising a protection circuit electrically connected to the power controller and the jack for cutting off the electrical connection between the power controller and the jack before the power controller is overloaded or for restricting an amount of electricity output to the power controller from the second electromagnetic inducting coil before the power controller is overloaded.
